(19) United States
(12) Patent Application Publication
(10) Pub. No.: US 2006/0155707 A1
(43) Pub. Date: Jul. 13, 2006

(54) Hyperlinks as visualizations of standing queries

(75) Inventor: Cezary Marcjan, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/035,259

(22) Filed: Jan. 13, 2005

(51) Int. Cl. G06F 7/00; G06F 17/30

(52) U.S. Cl. 707/10

(57) ABSTRACT

The subject invention provides a unique system and method that facilitate readily identifying that content associated with a hyperlink has been modified or changed in some way that may be of interest to the user. In particular, the target or active sites associated with a plurality of hyperlinks can be monitored for content changes. A user can determine the conditions for which the changes must satisfy before the user is notified of the changes. Various actions can be taken to notify the user of the change via the site's hyperlink when the conditions or queries are satisfied. In addition to general site monitoring, the user can specify specific locations of a site to monitor so that only the desired content on the page is monitored.

### TECHNICAL FIELD

The subject invention relates generally to hyperlinks and in particular to the visual modifications of hyperlinks to facilitate recognizing content associated with the hyperlink has changed.

### BACKGROUND OF THE INVENTION

Hyperlinks are commonly used in web browsers to identify a location of information. In general, a hyperlink is an image or portion of text on a web page that is linked to another web page, either on the same site or in another web site. Clicking on the link will take the user to another web page, or to another place on the same page. Words or phrases which serve as links are underlined, or appear in a different color, or both. Images that serve as links have a border around them, or they cause the cursor to change to a little hand as it passes over them.

Nowadays, hyperlinks can be used in conventional document browsing or as a means of indicating a location of a document. For example, when operating from the same network and server shares, one user can pass on a hyperlink (or link) of a document in an email to another user, for example, rather than providing the document as an attachment, which can consume valuable disk space over time. In these instances, the use of hyperlinks is consistent: they still identify a location of information and they operate in a similar manner as those on the internet.

Hyperlinks can be helpful in directing a user to some desired content. However, the traditional appearance of hyperlinks provides little if any information to a user aside from the content's location. Only minor attempts to remedy this have been taken. For example, in some cases, the color of the hyperlink may change to indicate that the user has previously viewed the content or visited the location of the content. However, this type of color change has more to do with the user's behavior and less or nothing to do with the content associated with the hyperlink.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to a system and/or methodology that facilitate readily identifying that content associated with a hyperlink has been modified or changed in some way that may be of interest to the user. In particular, the systems and methods of the invention provide for the monitoring of target or active sites associated with a plurality of hyperlinks. A user can set, program, or otherwise determine any number of conditions or queries. Depending on whether the conditions or queries are satisfied (and, in some cases, to what extent), various actions can be taken in response. For example, the link may be altered or converted to a different type of element, the link can change to a different color (e.g., random or specific), the link name can change, an icon or symbol can be appended to the link, or any other pre-defined action can be executed. Any of these various actions can be determined according to user preferences or by the system.

According to an aspect of the invention, a set of active links and their targets (e.g., corresponding content) can be registered with a monitoring agent. The monitoring agent scans and analyzes at least one of the following: the content of the targets, at least a subset of the targets, or at least a subset of the content—to determine whether any interesting changes to the content have occurred. The user can determine what kinds of changes constitute “changes of interest” and how often to check for such changes (e.g., every 10 minutes, every other day, every 30 seconds, etc.). When any change to the content is detected, the system and method can determine whether the change satisfies a condition or query. Thereafter, a corresponding action can be performed based at least in part on the condition or query that is satisfied.

According to another aspect of the invention, changes to content can be localized to particular locations on the page. For example, web pages typically include different banner advertisements at the top and bottom of the page and even on the left or right side of the page. In most cases, advertisements change frequently, however, the user is not usually interested in knowing when a banner ad has changed on a particular web page. Rather, the user is generally more interested in the more substantive content on the page. Thus, the user can specify one or more locations on the target object to monitor for changes. The target object or content can include but is not limited to web pages, documents, images, and/or program applications.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a hyperlink monitoring system in accordance with an aspect of the subject invention.

FIG. 2 is a block diagram of a hyperlink monitoring system that facilitates visualization of hyperlinks in accordance with another aspect of the subject invention.

FIG. 3 is a block diagram of a hyperlink monitoring and visualization system as it may interact between a client (local) machine and remote server in accordance with yet another aspect of the subject invention.

FIG. 4 is a block diagram of a schematic diagram of an exemplary search results page including at least one hyperlink being monitored by a monitoring agent in accordance with still another aspect of the subject invention.

FIG. 5 is a schematic diagram of an exemplary target object associated with a hyperlink that is being monitored for content changes in accordance with an aspect of the subject invention.

FIG. 6 is a schematic diagram of an exemplary target object associated with a hyperlink that is being monitored for content changes in accordance with an aspect of the subject invention.

FIG. 7 is a schematic diagram of exemplary target objects associated with their respective hyperlinks that are being monitored for consistent content changes in accordance with an aspect of the subject invention.

FIG. 8 is a flow chart illustrating an exemplary methodology for monitoring desired hyperlinks for content changes and modifying the hyperlink based at least in part on the content change in accordance with an aspect of the subject invention.

FIG. 9 is a flow chart illustrating an exemplary methodology for monitoring desired hyperlinks for content changes and modifying the hyperlink based at least in part on the content change in accordance with one specific implementation of the subject invention.

FIG. 10 illustrates an exemplary environment for implementing various aspects of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject invention can incorporate various inference schemes and/or techniques in connection with monitoring content of a target site for a particular hyperlink and then modifying the hyperlink according to changes to the content at the target site. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

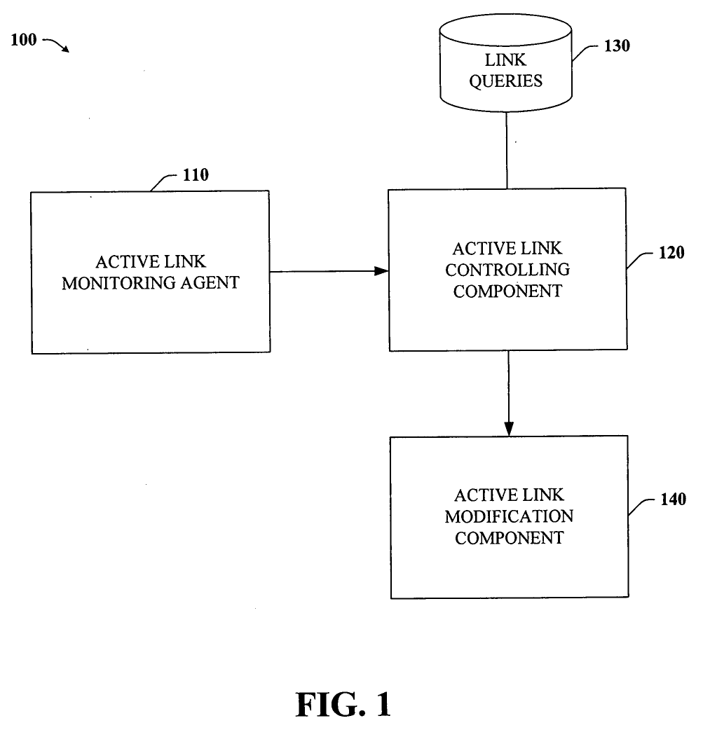

Referring now to FIG. 1, there is a general block diagram of a hyperlink monitoring and modification system 100 in accordance with an aspect of the subject invention. The system 100 includes an active link monitoring agent 110 that monitors one or more active links which correspond to their respective target sites. Information can be gathered or collected by the monitoring agent 110 and communicated to an active link controlling component 120. The controlling component 120 can examine the information communicated from the monitoring agent 110 and compare it to the one or more stored link queries 130. The link queries 130 comprise a plurality of different queries for a plurality of links (e.g., hyperlinks). For example, for any given link, at least one query can be set or programmed by a user. The query can include a set of conditions to be met or actions to be performed on the link when the condition(s) is satisfied.

Each query can correspond to at least one hyperlink and the associated target site. When content on a particular target site changes to an extent sufficient to satisfy the relevant query, an active link modification component 140 can be signaled to modify the hyperlink in some manner according to user preferences. The type or form of modification can be determined by the user on a per hyperlink basis or globally.

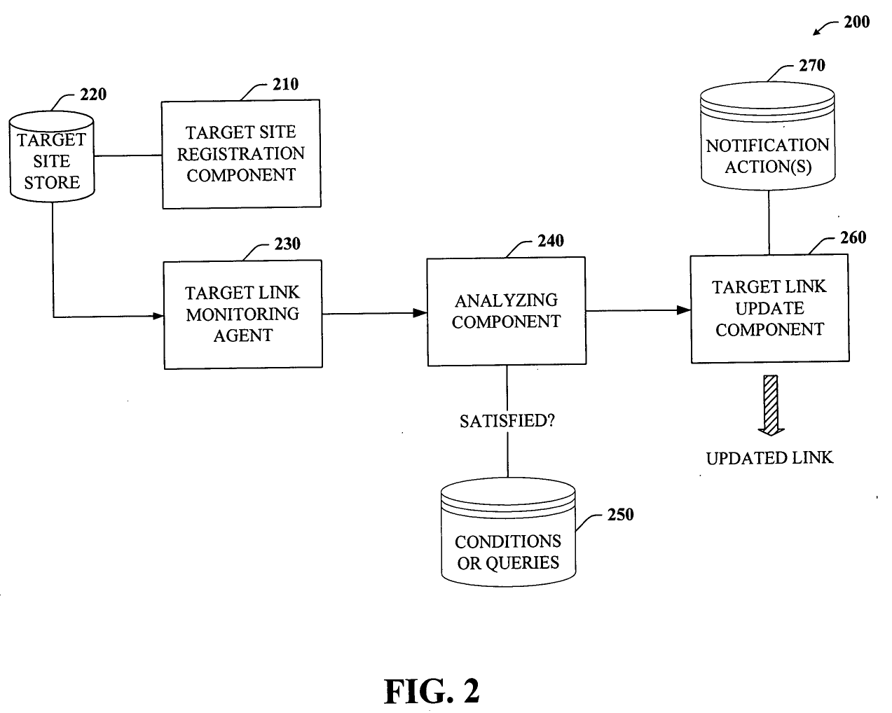

Turning now to FIG. 2, there is illustrated an advanced hyperlink monitoring system 200 in accordance with an aspect of the subject invention. The system 200 includes a target site registration component 210 that registers any number of target sites for which monitoring is desired. The target sites which have been selected for monitoring can be stored in a database 220 or similar memory store. Following registration, a target link monitoring agent 230 can receive a notification of a new target site and/or can be activated to monitor activity on such sites. In particular, specific areas of the site or particular types of content on the site can be communicated to the monitoring agent 230. As the agent 230 continues to watch for content changes to any one registered site, an analyzing component 240 can receive information from the monitoring agent 230. The analyzing component 240 can compare the respective conditions or queries for a particular site by retrieving them from a database 250 and then can determine whether the relevant conditions or queries for the site have been met.

For example, imagine that a user would like to be notified when the headline news content has changed on a website having a hyperlink www.news123.com. Because the website may including interesting (e.g., news content) and non-interesting content (e.g., banner advertisements and website sponsors), the user can specify what types of content and/or relative location(s) of the desired content are to be monitored by the monitoring agent 230. In this example, websites are typically organized in a tree structure layout; thus various types of content included on any website can be identified by their respective location along or in the tree structure. For any target site, whether it is a folder on a local hard drive, a table within a database, or a website, desired content on the site can be specified apart from the hyperlink. Content can be specified by a relative location in a content tree (e.g., relative to the root or other well defined node), absolute location in a rendered view, and/or absolute location in a content tree given by a node name or ID. In practice, users can indicate the desired content to monitor (e.g., by selecting a desired section or text box on the page) and the target registration component 210 can translate the user's input into the appropriate form that the monitoring agent 230 can understand. For instance, the registration component or some other component can convert the user's selection to a physical location on the page.

When the analyzing component 240 has determined that a change or query has been satisfied, it can notify a target link update component 260 (e.g., browser). The update component 260 can access the desired notification action 270 for the particular target link or site and then update the hyperlink accordingly. Examples of notification actions include changing the color of the hyperlink, modifying the title of the hyperlink to indicate that the desired content has changed, and/or adding a symbol to or removing a symbol from the hyperlink. Other types of notification actions are possible as well such as highlighting the hyperlink, drawing a line around the hyperlink, and/or adding some form of animation to the hyperlink (e.g., blinking text, fade-in/out text, etc.). The user can also receive an email or sound notification to alert it that at least one of its target links have changed. Alternatively or in addition, the user can simply refer to the hyperlink monitor list to glance at the hyperlinks to quickly ascertain whether at least one of its target websites has been updated.

In some cases, the user may also like to learn which target sites have not changed over a prolonged period of time. For example, no changes can indicate that the site is no longer updated or in use by the operator. As a result, the user may want to remove the site and hyperlink from the monitoring agent's list and/or stop referencing the site in general. Hence, the user can also set a condition or query for particular durations of time in which no changes are detected by the monitoring agent 230. For these types of sites, the corresponding hyperlink can also be modified with an appropriate symbol, icon, color change, or the like to indicate that no changes have been detected after P time.

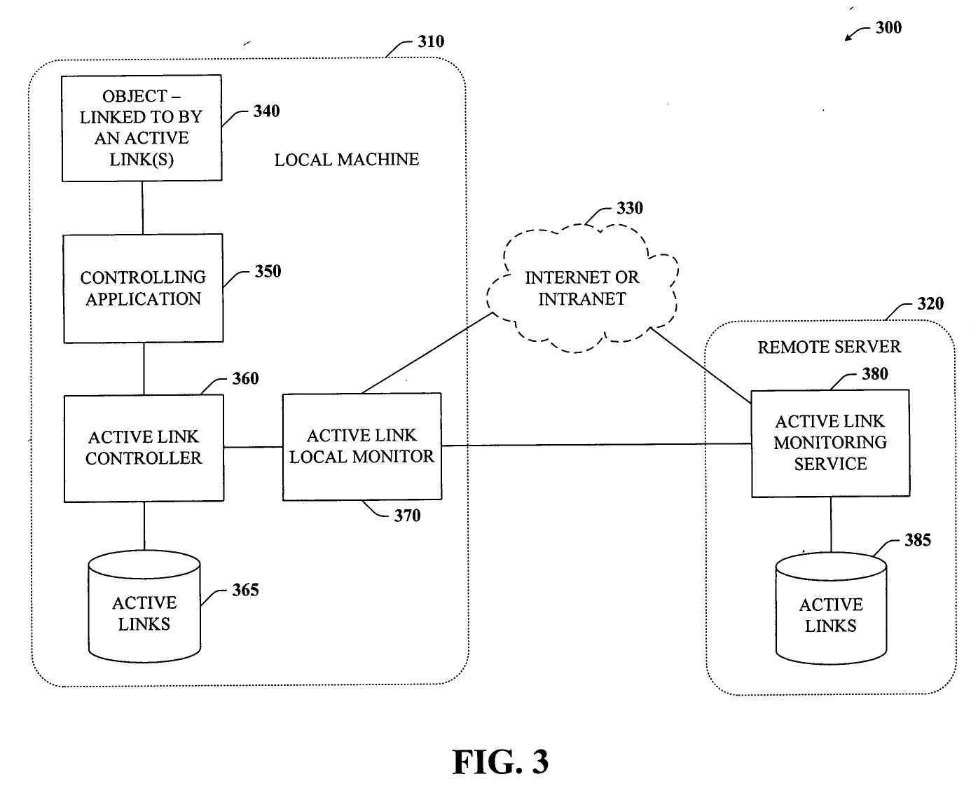

Referring now to FIG. 3, there is illustrated a block diagram of an exemplary monitoring system architecture 300 that includes a local machine 310 interacting with a remote server 320 via a network 330 to facilitate monitoring an active link object (site). In particular, the local machine 310 includes an object 340 having an active link associated therewith. The object 340 can be any one of a document, a website, and/or a file. Furthermore, the object 340 can be controlled or accessed by an appropriate controlling application 350.

In general, an active link controller 360 controls a plurality of active links 365 which have been registered for monitoring by an active link local monitor 370. Via the internet or intranet network 330, the active link local monitor 370 can communicate with an active link monitoring service 380 located on the remote server 320. It should be appreciated that the (remote) active link monitoring service 380 may be responsible for monitoring any number of active links 385 for a plurality of local machines or for one local machine. For instance, when a particular active link (385) has been changed in some desired manner, the monitoring service 380 locates the appropriate local machine 310, if any, and then communicates the information to the active link local monitor 370. The local monitor 370 can notify the active link controller 360, which may verify that the active link 385/365 has been registered on the particular local machine 310 and then determine the manner in which to update the active link for the object 340. For example, the active link for the object 340 can then be updated or modified by way of the controlling application 350.

It should be appreciated that the local machine-remote server architecture 300 depicted in FIG. 3 is merely one example of such interaction. Other arrangements are possible to carry out the subject invention.

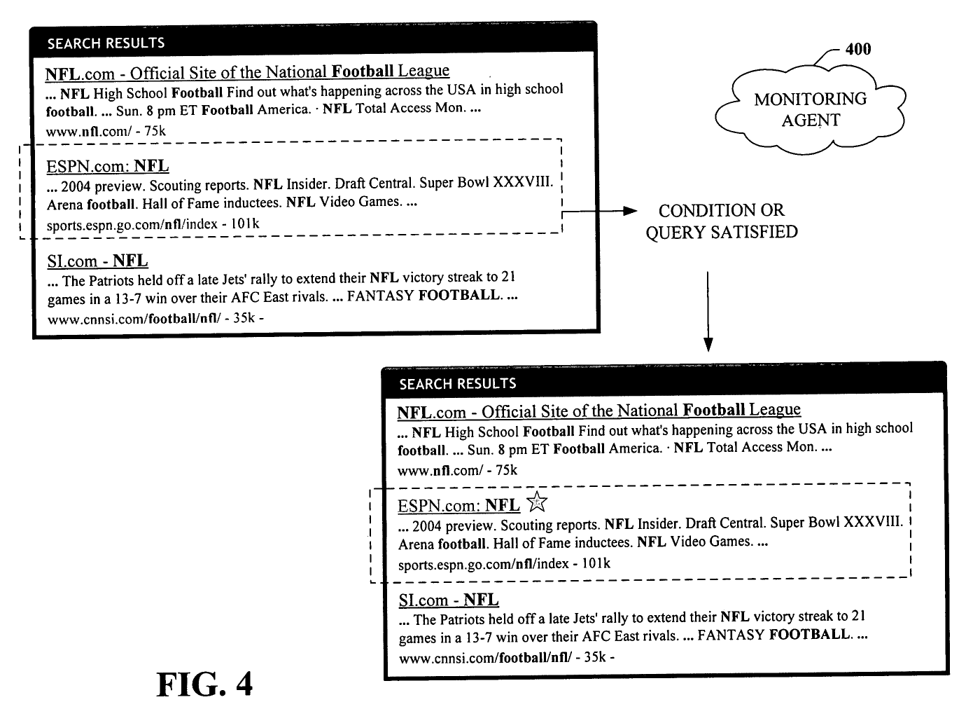

The monitoring of one or more active links can be performed in various ways as specified by a user. The images illustrated in FIGS. 4-7 represent a few different techniques for monitoring at least one active link for changes to the content associated therewith. Beginning with FIG. 4, suppose a user has registered ESPN.com: NFL with a monitoring agent 400 to monitor the NFL related content for changes and/or updates to the content. Assuming that a condition or query has been satisfied, the active link can be modified as indicated by the addition of a symbol or icon next to the active link title. Once the user has returned or revisited the updated site, the symbol can be removed or can remain depending on the user's settings. If the visual notification (e.g., symbol, color change, title change, etc.) remains after the user has clicked on the modified link, the link can be modified in a different manner specified by the user when subsequent changes are detected by the monitoring agent.

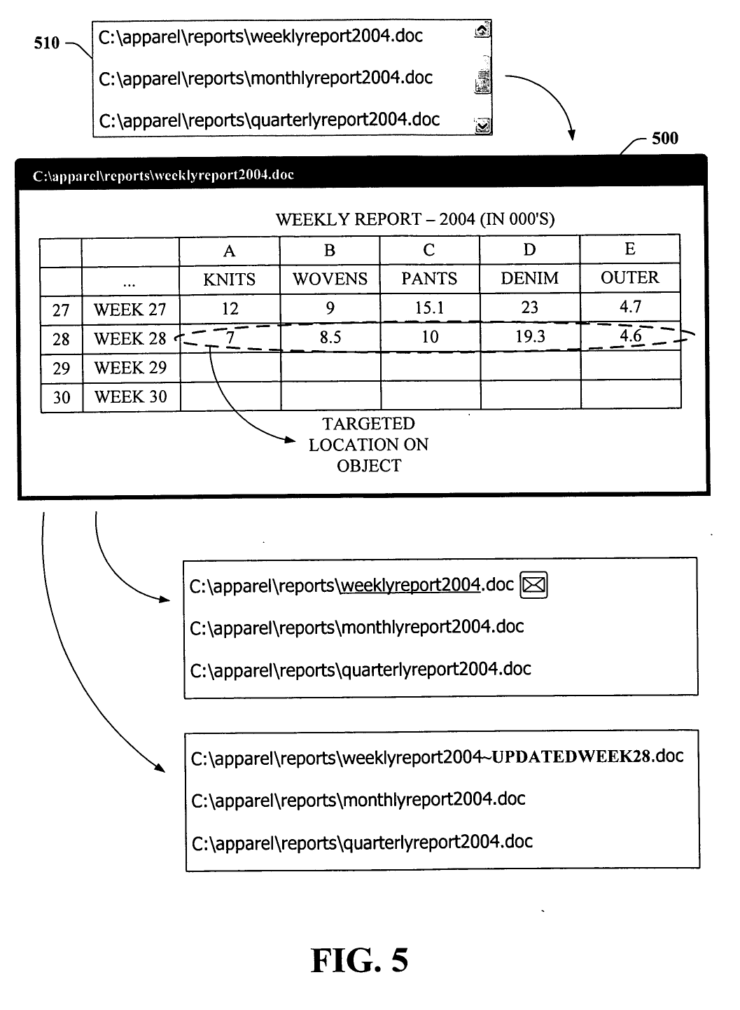

In FIG. 5, there is depicted the monitoring of an object 500 having an active link associated therewith. In this example, the object 500 is a document or file. Imagine that a user has a list 510 of active links that are being monitored for content changes. Next, imagine that the object corresponding to the active link C:\apparel\reports\weeklyreport2004.doc has been updated. More specifically, the user may specify to watch for a change to content at a particular location of the object. In this object 500, the content to watch is located at row 28, columns A through E. The user can select this area for monitoring, and the monitoring agent or some other component in communication with the monitoring agent can convert the selected area to the respective page coordinates (e.g., line:column or row:column).

To notify the user that the desired content in the object 500 has changed in some way,-at least a portion of the active link title can be underlined, for example. Alternatively or in addition, an email symbol can also be added next to the active link title to indicate that an email notification was sent to the user. The active link title can also be changed as desired by the user. For example, the user can specify a particular phrase to be added to the title such as UPDATEDWEEK28. The phrase can be dynamic and automatically correspond to the content that has changed.

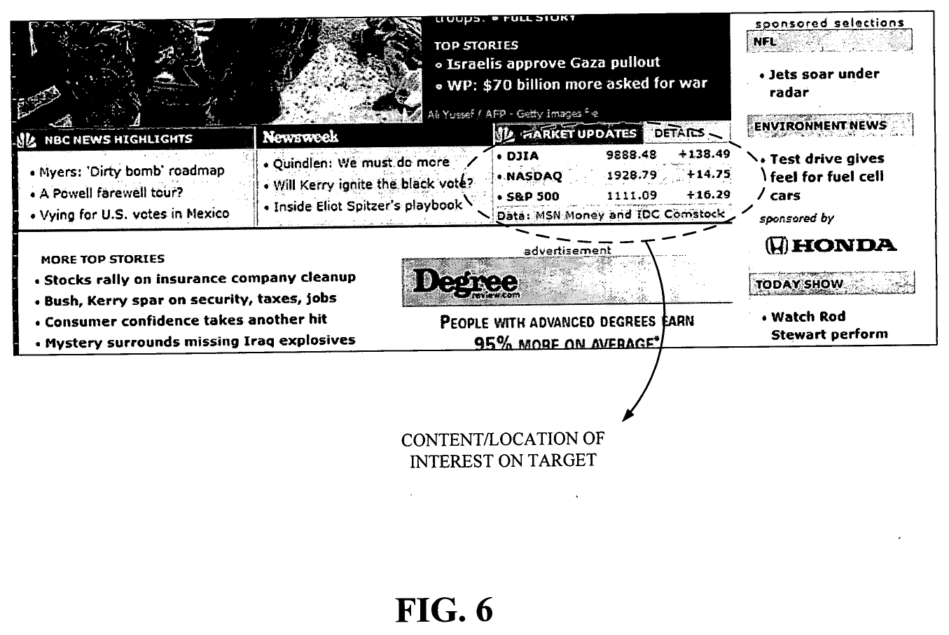

Websites typically include many different types of content that may not be of interest to the user when changes occur. For example, advertisements and sponsored sections can change frequently but may not be content of interest to the user. As indicated in FIG. 6, the user may only be interested in changes to the stock market. Thus, changes to content such as headline news (e.g., top stories, news highlights, etc.), sports, and entertainment news may be of no interest to the particular user. Hence, the user can specify which content on a web page or site to monitor. The location(s) of the content to monitor can be identified by its location according to the tree structure of the page or site. Though the arrangement of various types of content on the web page or site can change, the actual location as indicated by the page's tree structure is unlikely to change at all or with any notable frequency to hinder the monitoring processing.

Although not shown in the figure, specific notification actions can be set depending on the type or level of change in the content on at least one target site. For example, with respect to stock prices, the user can indicate that if the price of stock W exceeds $50, then notification action D is to be performed; however, if the price of stock W exceeds $75, then notification action E is to be performed; etc. . . . Hence, the quality of the content that has changed can be parsed and analyzed as well in order to determine the proper notification action to perform.

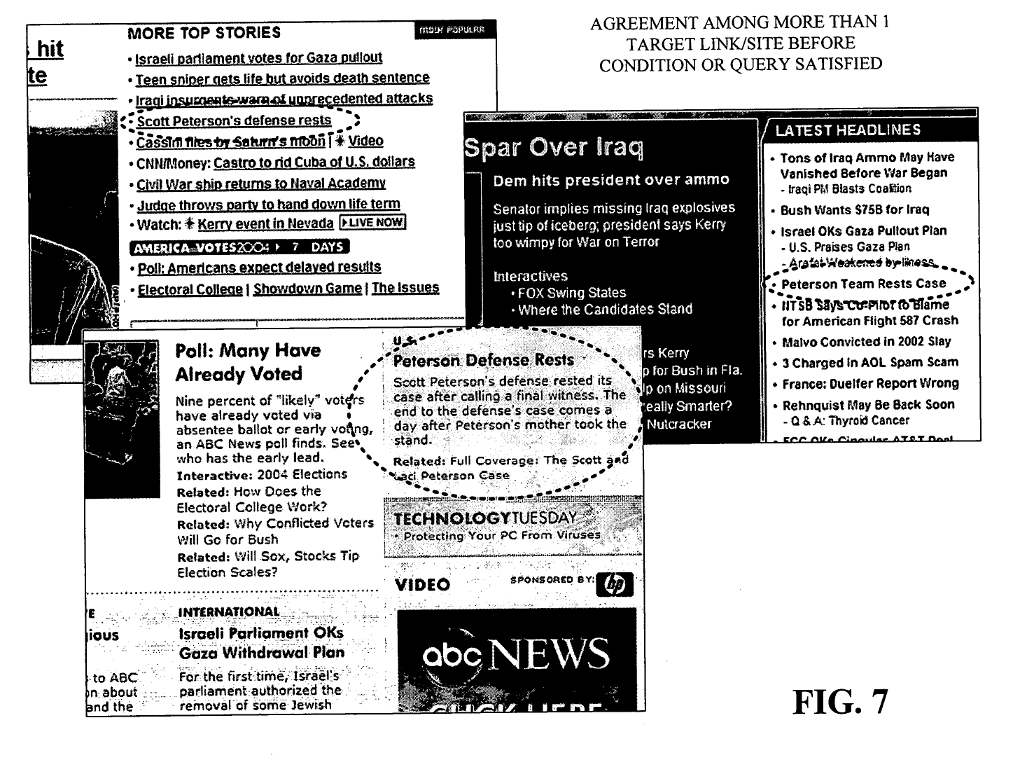

A monitoring agent or service can also monitor the relationship between multiple target sites. For example, a query can be set to monitor more than one target site before notifying the user of a change to content on one or more of those target sites. FIG. 7 demonstrates this aspect of the subject invention. Suppose that the user would like notification when at least three different news sites depict a similar top story on its home (front) page. As can be seen in the figure, there are three different target sites represented—each including a “headline” for “Peterson”. By requesting that at least a minimum number of sites are reporting on a similar top news story, the user can be personally certain that the news story is worthy of his/her attention and/or can be trusted because there is agreement among multiple sites.

Various methodologies in accordance with the subject invention will now be described via a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

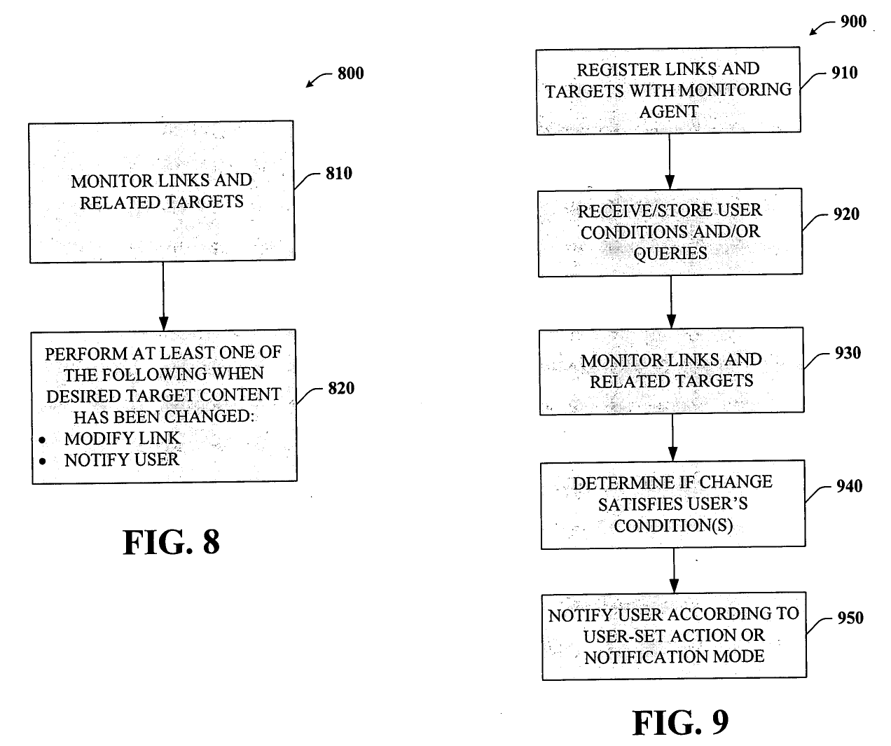

Referring now to FIG. 8, there is a flow diagram of an exemplary methodology 800 that facilitates monitoring hyperlinks using standing queries in accordance with an aspect of the subject invention. The process 800 involves monitoring one or more active links and their corresponding target sites at 810. At 820, at least one of the following can be performed when desired content of the target site has changed: the active link (hyperlink) can be modified as indicated by the user and/or the user can receive a notification that content associated with the active link has recently changed. A monitoring component can monitor the target sites which have been registered by the user on a constant basis or in timed intervals. In addition, specific types of content can be monitored on any one target site. This can be particularly useful since content not related to the site such as banner advertisements can change frequently but not be of interest to the user.

Turning now to FIG. 9, there is illustrated a flow diagram of an exemplary methodology 900 that further facilitates monitoring hyperlinks using standing queries in accordance with an aspect of the subject invention. The methodology 900 involves registering one or more active links and their related target sites with a monitoring agent or service at 910. At 920, user-set conditions and/or queries for the respective active links can be stored in a database for example. At 930, the registered active links and their corresponding sites can be monitored for content changes. When a change is detected, it can be determined whether the change satisfies the user's query or condition(s) at 940. Following, the user can be notified at 950 that the content on one or more of his/her registered sites have changed in some desired way. The type of notification can be specific to the site or link or can be applicable to any of the registered sites/links. For example, the user can indicate that he/she wants an email notification when any link or site has been changed. Alternatively or in addition, the user can specify particular notification actions for certain links. For instance, the user may want to see a color change or a change to the link title for shopping related sites.

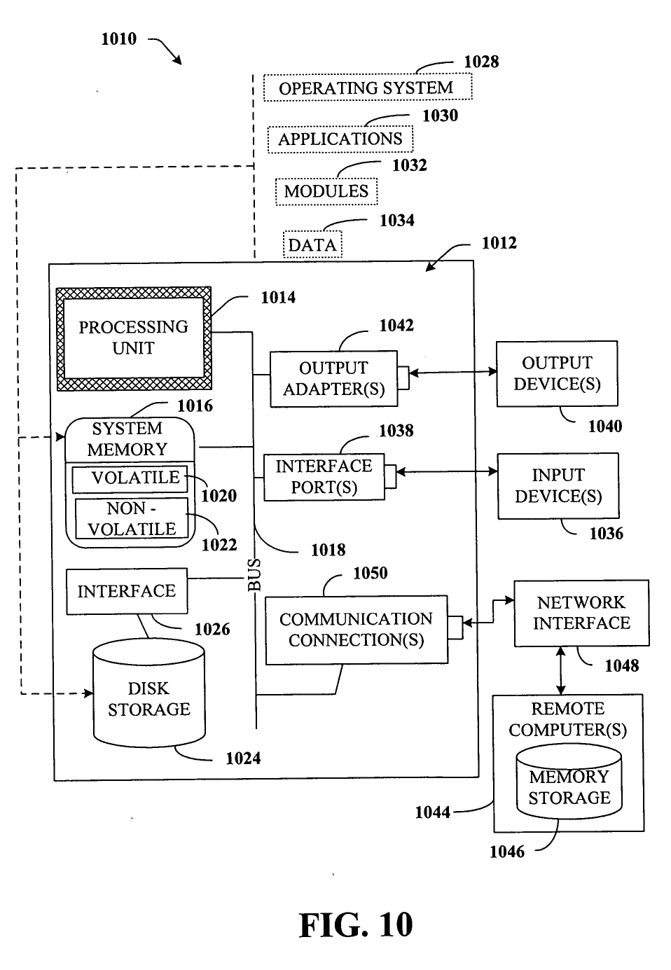

In order to provide additional context for various aspects of the subject invention, FIG. 10 and the following discussion are intended to provide a brief, general description of a suitable operating environment 1010 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1010 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hyperlink visualization and notification system comprising:
an active link monitoring component that monitors content changes on at least a portion of at least one active link target sites which correspond to respective hyperlinks and collects data from the at least one portion of the at least one target site; and
an active link controller that analyzes the data collected by the monitoring component and determines whether to visually modify at least one of the hyperlinks based at least in part upon at least one query associated with at least one of the hyperlinks.

2. The system of claim 1, the data collected comprises information indicating that at least a portion of desired content on at least one target site has changed.

3. The system of claim 1, further comprising a query database comprising one or more queries whereby at least one query is connected to at least one active link target site that is being monitored.

4. The system of claim 3, wherein each query comprises one or more conditions to be satisfied before a user is notified that content on the target site has changed since a previous viewing of the site.

5. The system of claim 3, wherein each query comprises one or more actions to be performed on the respective hyperlink when the relevant conditions are satisfied.

6. The system of claim 5, the one or more actions comprise sending an email notification, sending a sound notification, and modifying the hyperlink appearance.

7. The system of claim 1, further comprising a registration component that maintains a listing of the hyperlinks and their associated active link target sites that are indicated for monitoring.

8. The system of claim 1, further comprising a notification component that notifies a user when desired content on at least one active link target site has changed since the user's previous viewing of the site.

9. The system of claim 1, the active link monitoring component resides on at least one of a server or a client.

10. The system of claim 1, the active link controller component resides on at least one of a server or a client.

11. The system of claim 1, the at least a portion of the content desired for notification is identified by an identifier or relative location on the target.

12. A method that facilitates hyperlink visualization and notification comprising:
monitoring content changes on at least one portion of one or more active link target sites, whereby the at least one portion of the one or more active link target sites corresponds to a respective hyperlink;
collecting data from the target sites; and
analyzing the data collected by the monitoring component to determine whether to visually modify at least one of the hyperlinks based at least in part upon at least one query associated with at least one of the hyperlinks.

13. The method of claim 12, further comprising populating a query database with one or more queries whereby at least one query is connected to at least one active link target site that is being monitored.

14. The method of claim 13, wherein each query comprises one or more conditions to be satisfied before a user is notified that content on the target site has changed since a previous viewing of the site.

15. The system of claim 13, wherein each query comprises one or more actions to be performed on the respective hyperlink when the relevant conditions are satisfied.

16. The system of claim 15, the one or more actions comprise sending an email notification, sending a sound notification, and modifying the hyperlink appearance.

17. The method of claim 12, further comprising registering the hyperlinks and their associated active link target sites for which monitoring is desired with a monitoring agent.

18. The method of claim 12, further comprising notifying a user when desired content on at least one active link target site has changed since the user's previous viewing of the site.

19. The method of claim 12, further comprising visually modifying at least one hyperlink when desired content on the corresponding active link target site has changed in a desired manner.

20. A system that facilitates hyperlink visualization and notification comprising:
means for monitoring content changes on one or more active link target sites which correspond to respective hyperlinks;
means for collecting data from the target sites; and
means for analyzing the data collected by the monitoring component to determine whether to visually modify at least one of the hyperlinks based at least in part upon at least one query associated with at least one of the hyperlinks.
